(19) United States
(12) Patent Application Publication
(10) Pub. No.: US 2017/0256190 A1
(43) Pub. Date: Sep. 7, 2017

(54) Method of RGBW compensation based on color aberrations of white subpixels and apparatus thereof

(71) Applicant: Shenzhen China Star Optoelectronics Technology Co., Ltd., Shenzhen, Guangdong (CN)

(72) Inventor: Yufeng JIN, Shenzhen, Guangdong (CN)

(73) Assignee: Shenzhen China Star Optoelectronics Technology Co., Ltd., Shenzhen, Guangdong (CN)

(21) Appl. No.: 14/898,275

(22) PCT Filed: Sep. 21, 2015
(86) PCT No.: PCT/CN2015/090138

§ 371 Date: Dec. 14, 2015

(30) Foreign Application Priority Data
Sep. 17, 2015 (CN) 201510593712.3

(51) Int. Cl. G09G 3/20; G09G 3/3208

(52) U.S. Cl. CPC G09G 3/2003; G09G 3/3208; G09G 2320/0666; G09G 2300/0452; G09G 2320/0693; G09G 2360/16

(57) ABSTRACT

The present invention discloses a method of RGBW compensation based on color aberrations of white subpixel and an apparatus thereof: when aberrations exist between a color coordinate point Wₛ of white subpixel and a standard white color coordinate point W_{d} under sRGB, analyzing color coordinates of every subpixel on the RGBW panel, and then dividing a triangle with vertices points Rₛ, Gₛ and Bₛ into three triangle regions based on Wₛ as the center point; based on ranges of the three triangle regions, a triangle region where W_{d} is located is confirmed; afirst data is calibrated by performing compensating the white subpixel corresponding by the center point Wₛ via a predetermined normalized proportion through two subpixels corresponding to the other two points within the triangle region surrounding and locating W_{d}. Through the aforementioned manner, the present invention is capable of calibrating aberrations of white subpixels in order to normalize images of RGBW panels.

### TECHNICAL FIELD

The present invention relates to a display technology field, and particularly to a method of RGBW compensation based on color aberrations of white subpixels and an apparatus thereof.

### BACKGROUND

With strengthening of people's awareness of energy conservation, energy consumptions of products gradually turn into an important factor of product. Under a motivation of awareness of energy conservation, developments of RGBW come afterwards. LG Display added white subpixel based on RGB foundation inventively to form RGBW 4K. Light transmittance of panels of RGBW 4K is increasing apparently with participation of white subpixel, and luminance of panel increases 1.5 times based on the foundation of panels of traditional RGB 4K.

Nowadays, a variety of algorithms exists in switching from RGB signals to RGBW signals, and comprises traditional algorithms and new algorithms in research. However, after applying those algorithms to switch RGB signals into RGBW signals particularly in Organic Light Emitting Display (OLED), aberrations are found between color coordinate points of actual white subpixels (W-subpixel) and standard white color coordinate points under sRGB; the white subpixels have larger color aberrations.

### DISCLOSURE OF INVENTION

A technical problem mainly solved in the present invention is to provide a method of RGBW compensation based on color aberrations of white subpixel and an apparatus thereof in order to normalize images of RGBW panels and be capable of calibrating aberrations of white subpixels.

To solve the aforementioned technical problem, a technical solution applied in the present invention is: a method of RGBW compensation is provided based on color aberrations of white subpixels, aberrations exist between a color coordinate point Wₛ of white subpixels of image pixels on a RGBW panel and a standard white color coordinate point W_{d} under sRGB before compensating, and the method comprises: inserting the image pixels based on a first data of RGBW color space; analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Wₛ as the center point; confirming a triangle region where the color coordinate point is located based on ranges of the three triangle regions, RₛGₛWₛ, RₛBₛWₛ, BₛGₛWₛ; performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d}; exporting the post-compensated a second data of image pixels based on the RGBW color space;

wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point comprises: if the color coordinate point W_{d} is located within the triangle region BₛGₛWₛ, a normalized proportion calculating a luminance among subpixel, the blue subpixel, green subpixel and white subpixel, is BₛY, GₛY, WₛY, and BₛY+GₛY+WₛY=1; performing calibration process to the first data by applying the normalized proportion BₛY, GₛY, WₛY to obtain a second data of image pixels based on the RGBW color space,

R_{fo}(i)=Rₒ(i)

G_{fo}(i)=Gₒ(i)+Wₒ(i)*GₛY(i)

B_{fo}(i)=Bₒ(i)+Wₒ(i)*BₛY(i)

W_{fo}(i)=Wₒ(i)*WₛY(i),

wherein, Rₒ(i), Gₒ(i), Bₒ(i), Wₒ(i) is a first data of a pixel point i, R_{fo}(i), G_{fo}(i), B_{fo}(i), W_{fo}(i) is a second data of the pixel point i, BₛY(i), GₛY(i), WₛY(i) is a normalized proportion of a luminance among a blue subpixel, green subpixel and white subpixel of the pixel point i;

if the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1;

performing calibration process to the first data by applying the normalized proportion BₛY, RₛY, WₛY to obtain a second data of image pixels based on the RGBW color space,

R_{fo}(j)=Rₒ(j)+Wₒ(j)*RₛY(j)

G_{fo}(j)=Gₒ(j)

B_{fo}(j)=Bₒ(j)+Wₒ(j)*BₛY(j)

W_{fo}(j)=Wₒ(j)*WₛY(j),

wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY (j), RₛY(j), WₛY(j) is a normalized proportion of a luminance among a blue subpixel, red subpixel and white subpixel of the pixel point j;

if the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1;

performing calibration process to the first data by applying the normalized proportion RₛY, GₛY, WₛY to obtain a second data of image pixels based on the RGBW color space,

R_{fo}(k)=Rₒ(k)+Wₒ(k)*RₛY(k)

G_{fo}(k)=Gₒ(k)+Wₒ(k)*GₛY(k)

B_{fo}(k)=Bₒ(k)

W_{fo}(k)=Wₒ(k)*WₛY(k),

wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

Wherein, the normalized proportion BₛY, GₛY, WₛY is obtained according to a formula 1 and the formula 1 is:

$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, the normalized proportion BₛY, RₛY, WₛY is obtained according to a formula 2, and the formula 2 is:

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} , \\ {B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, the normalized proportion RₛY, GₛY, WₛY is obtained according to a formula 3, and the formula 3 is:

$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

To solve the aforementioned technical problem, another technical solution applied in the present invention is: providing a method of RGBW compensation based on color aberrations of white subpixel, wherein, aberrations exist between a color coordinate point Wₛ of white subpixel of image pixels on a RGBW panel and a standard white color coordinate point W_{d} under sRGB before compensating, and the method comprises: inserting the image pixels based on a first data of RGBW color space; analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Wₛ as the center point; confirming a triangle region where the color coordinate point is located based on ranges of the three triangle regions, RₛGₛWₛ, RₛBₛWₛ, BₛGₛWₛ; performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d}; exporting the post-compensated a second data of image pixels based on the RGBW color space.

Wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d} comprises: if the color coordinate point W_{d} is located within the triangle region BₛGₛWₛ, a normalized proportion calculating a luminance among subpixel, the blue subpixel, green subpixel and white subpixel, is BₛY, GₛY, WₛY, and BₛY+GₛY+WₛY=1; performing calibration process to the first data by applying the normalized proportion BₛY, GₛY, WₛY to obtain a second data of image pixels based on the RGBW color space,

R_{fo}(i)=Rₒ(i)

G_{fo}(i)=Gₒ(i)+Wₒ(i)*GₛY(i)

B_{fo}(i)=Bₒ(i)+Wₒ(i)*BₛY(i)

W_{fo}(i)=Wₒ(i)*WₛY(i),

wherein, Rₒ(i), Gₒ(i), Bₒ(i), Wₒ(i) is a first data of a pixel point i, R_{fo}(i), G_{fo}(i), B_{fo}(i), W_{fo}(i) is a second data of the pixel point i, BₛY(i), GₛWₛY(i) is a normalized proportion of a luminance among a blue subpixel, green subpixel and white subpixel of the pixel point i.

Wherein, the normalized proportion BₛY, GₛY, WₛY is obtained according to a formula 1, and the formula 1 is:

$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, steps for performing compensating the white subpixel corresponding by the center point Wₛ via a predetermined normalized proportion to calibrated the first data through the two subpixels corresponding to the other two color coordinate points, except the center point Wₛ, within the triangle region surrounding and locating the color coordinate point W_{d} comprises: if the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1; performing calibration process to the first data by applying the normalized proportion BₛY, RₛY, WₛY to obtain a second data of image pixels based on the RGBW color space,

R_{fo}(j)=Rₒ(j)+Wₒ(j)*RₛY(j)

G_{fo}(j)=Gₒ(j)

B_{fo}(j)=Bₒ(j)+Wₒ(j)*BₛY(j)

W_{fo}(j)=Wₒ(j)*WₛY(j),

wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, red subpixel and white subpixel of the pixel point j.

Wherein, the normalized proportion BₛY, RₛY, WₛY is obtained according to a formula 2, and the formula 2 is:

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} , \\ {B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d} comprises: if the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1; performing calibration process to the first data by applying the normalized proportion RₛY, GₛY, WₛY to obtain a second data of image pixels based on the RGBW color space,

R_{fo}(k)=Rₒ(k)+Wₒ(k)*RₛY(k)

G_{fo}(k)=Gₒ(k)+Wₒ(k)*GₛY(k)

B_{fo}(k)=Bₒ(k)

W_{fo}(k)=Wₒ(k)*WₛY(k),

wherein, Rₒ(k), Gₒ(k), Bₒ(k), Wₒ(k) is a first data of a pixel point k, R_{fo}(k), G_{fo} (k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

Wherein, wherein, the normalized proportion RₛY, GₛY, WₛY is obtained according to a formula 3, and the formula 3 is:

$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

To solve the aforementioned technical problem, another technical solution applied in the present invention is: an apparatus of RGBW compensation is provided based on color aberrations of white subpixel, aberrations exist between a color coordinate point Wₛ of white subpixel of image pixels on a RGBW panel and a standard white color coordinate point W_{d} under sRGB before compensating, and the apparatus comprises: an inserting module, used in inserting the image pixels based on a first data of RGBW color space; a dividing module, used in analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Wₛ as the center point; a confirming module, used in confirming a triangle region where the color coordinate point is located based on ranges of the three triangle regions, RₛGₛWₛ, RₛBₛWₛ, BₛGₛWₛ; a compensating module, used in performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d}; an exporting module, used in exporting the post-compensated a second data of image pixels based on the RGBW color space.

Wherein, the compensating module comprises: a first calculating unit, used in while the color coordinate point W_{d} is located within the triangle region BₛGₛWₛ, a normalized proportion calculating a luminance among subpixel, the blue subpixel, green subpixel and white subpixel, is BₛY, GₛY, WₛY, and BₛY+GₛY+WₛY=1; a first calibration unit, used in performing the calibration process to the first data by applying the normalized proportion BₛYₛ, GₛY, WₛY to obtain a second data of image pixels based on the RGBW color space,

R_{fo}(i)=Rₒ(i)

G_{fo}(i)=Gₒ(i)+Wₒ(i)*GₛY(i)

B_{fo}(i)=Bₒ(i)+Wₒ(i)*BₛY(i)

W_{fo}(i)=Wₒ(i)*WₛY(i),

wherein, Rₒ(i), Gₒ(i), Bₒ(i), Wₒ(i) is a first data of a pixel point i, R_{fo}(i), G_{fo}(i), B_{fo}(i), W_{fo}(i) is a second data of the pixel point i, BₛY(i), GₛY(i), WₛY(i) is a normalized proportion of a luminance among a blue subpixel, green subpixel and white subpixel of the pixel point i.

Wherein, the normalized proportion BₛY, GₛY, WₛY is obtained according to a formula 1, and the formula 1 is:

$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, the compensating module comprises: a second calculating unit, used in while the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1; a second calibration unit, used in performing calibration process to the first data by applying the normalized proportion BₛY, RₛY, WₛY to obtain a second data of image pixels based on the RGBW color space,

R_{fo}(j)=Rₒ(j)+Wₒ(j)*RₛY(j)

G_{fo}(j)=Gₒ(j)

B_{fo}(j)=Bₒ(j)+Wₒ(j)*BₛY(j)

W_{fo}(j)=Wₒ(j)*WₛY(j),

wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) i s a normalized proportion of a luminance among a blue subpixel, red subpixel and white subpixel of the pixel point j.

Wherein, the normalized proportion BₛY, RₛY, WₛY is obtained according to a formula 2, and the formula 2 is:

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} Y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} , \\ {B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, the compensating module comprises: a third calculating unit, used in while the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1; a third calibration unit, used in performing calibration process to the first data by applying the normalized proportion RₛY, GₛY, WₛY to obtain a second data of image pixels based on the RGBW color space,

R_{fo}(k)=Rₒ(k)+Wₒ(k)*RₛY(k)

G_{fo}(k)=Gₒ(k)+Wₒ(k)*GₛY(k)

B_{fo}(k)=Bₒ(k)

W_{fo}(k)=Wₒ(k)*WₛY(k),

wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

Wherein, the normalized proportion RₛY, GₛY, WₛY is obtained according to a formula 3, and the formula 3 is:

$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} Y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ {R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

The present invention can be concluded with the following advantages: as compared to the existing prior art, when aberrations exist between a color coordinate point Wₛ of white subpixel of image pixels and a standard white color coordinate point W_{d} under sRGB, analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions based on taking the color coordinate point Wₛ as the center point; based on ranges of the three triangle regions, RₛGₛWₛ, RₛBₛWₛ, BₛGₛWₛ, a triangle region where the color coordinate point is located is confirmed; the first data is calibrated by performing compensating the white subpixel corresponding by the center point s via a predetermined normalized proportion through two subpixels corresponding to the other two color coordinate points, except the center point Wₛ, within the triangle region surrounding and locating the color coordinate point W_{d}. Because the first data can be calibrated by performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d}; therefore, the situation of aberrations of white subpixels can be calibrated specifically and further images of GRBW panels can be normalized.

### BRIEF DESCRIPTION OF THE DRAWINGS

FIG. 1 is a flowchart of an embodiment representing a method of RGBW compensation based on color aberrations of white subpixel in the present invention.

FIG. 2 is schematic diagram showing positions of four subpixels with reference to chromaticity diagram in an embodiment.

FIG. 3 is a flowchart of another embodiment representing a method of RGBW compensation based on color aberrations of white subpixel in the present invention.

FIG. 4 is a schematic diagram of a first data based on RGB color space transferred from original data based on RGBW color space.

FIG. 5 is a flowchart of still another embodiment representing a method of RGBW compensation based on color aberrations of white subpixel in the present invention.

FIG. 6 is a flowchart of still another embodiment representing a method of RGBW compensation based on color aberrations of white subpixel in the present invention.

FIG. 7 is a schematic diagram showing a structure of an apparatus of an embodiment of RGBW compensation based on color aberrations of white subpixel.

FIG. 8 is a schematic diagram showing a structure of an apparatus of another embodiment of RGBW compensation based on color aberrations of white subpixel.

FIG. 9 is a schematic diagram showing a structure of an apparatus of still another embodiment of RGBW compensation based on color aberrations of white subpixel.

FIG. 10 is a schematic diagram showing a structure of still another apparatus of an embodiment of RGBW compensation based on color aberrations of white subpixel.

### DETAILED DESCRIPTION OF THE PREFERRED EMBODIMENTS

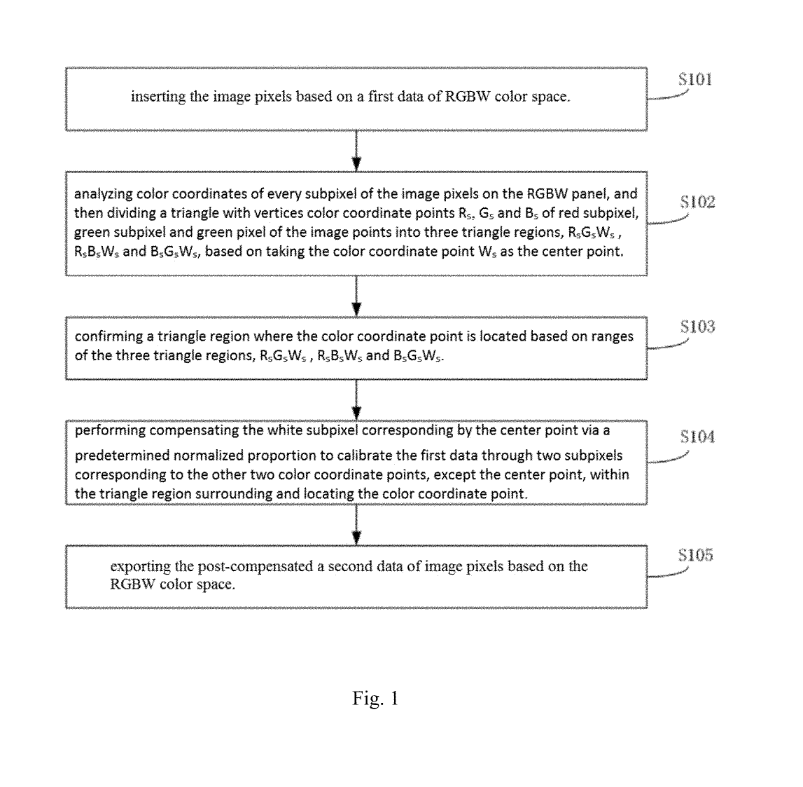

Detailed descriptions will be given along with the embodiment illustrated in the attached drawings. FIG. 1 is a flowchart of an embodiment representing a method of RGBW compensation based on color aberrations of white subpixel in the present invention.

Refer to FIG. 1, FIG. 1 is a flowchart of an embodiment representing a method of RGBW compensation based on color aberrations of white subpixel in the present invention. Before performing compensating via method adopted in the present invention, aberrations exist between a color coordinate point Wₛ of white subpixel of image pixels on a RGBW panel and a standard white color coordinate point W_{d} under sRGB, and the method comprises:

step S101: inserting the image pixels based on a first data of RGBW color space.

step S102: analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Wₛ as the center point.

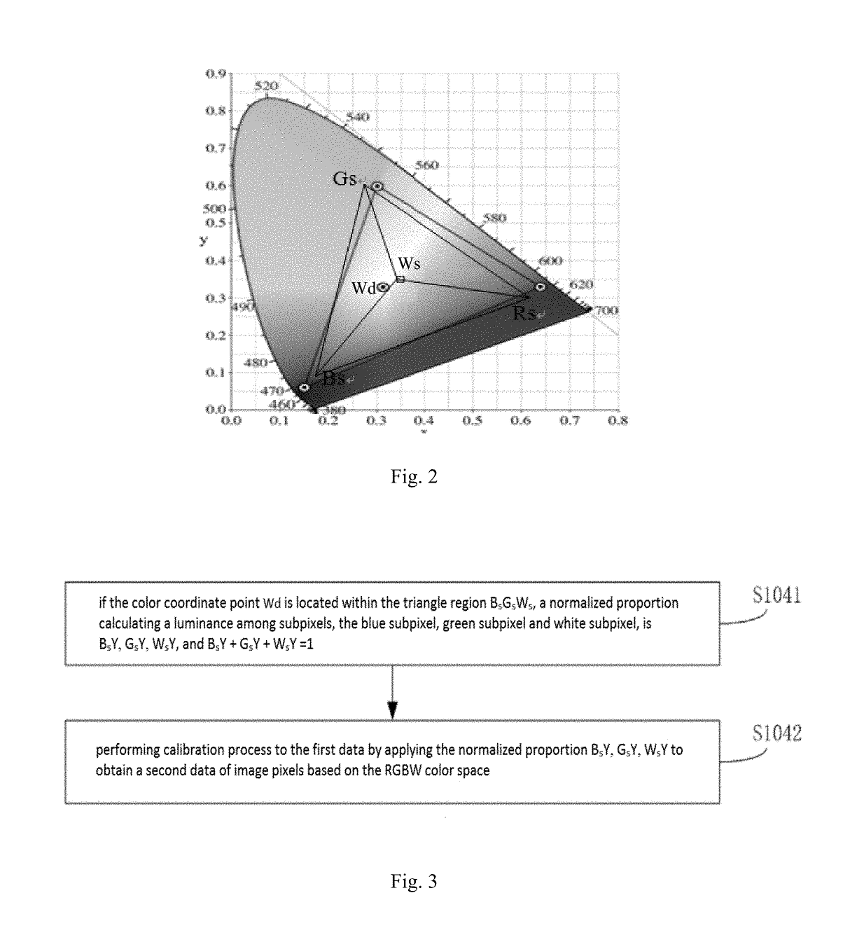

Respective subpixel of image pixels on RGBW panels can be represented by a particular coordinate point with reference to chromaticity diagram, and the particular coordinate point herein has a particular color coordinate value (x,y). There are four kinds of subpixels in the image pixels on RGBW panels, and those are red subpixels, green subpixels, blue subpixels and white subpixels respectively. Refer to FIG. 2, these four subpixels are corresponding to the color coordinate points, Rₛ, Gₛ, Bₛ and Wₛ, positioned in the surrounding triangle RₛGₛBₛ, and the triangle RₛGₛBₛ is divided into three triangles regions, RₛGₛWₛ, RₛBₛWₛ, BₛGₛWₛ, based on taking the color coordinate point Wₛ as the center point.

Step 103: confirming a triangle region where the color coordinate point is located based on ranges of the three triangle regions, RₛGₛWₛ, RₛBₛWₛ, BₛGₛWₛ.

Right after ranges of the three triangle regions, RₛGₛWₛ, RₛBₛWₛ, BₛGₛWₛ, are confirmed, the color coordinate point W_{d} located within a triangle region can be confirmed as well, as shown in FIG. 2. In a particular example, a coordinate value of the standard white color coordinate point W_{d} under sRGB is (0.3127,0.329) (as shown in white circle of the triangle RₛGₛBₛ), and a coordinate value of the color coordinate point Wₛ of the image pixels is (0.34,0.35) (as shown in the white block in the triangle RₛGₛBₛ); the triangle region where W_{d} locating is BₛGₛWₛ.

Step 104: performing compensating the white subpixel corresponding by the center point Wₛ via a predetermined normalized proportion to calibrate the first data through two subpixels corresponding to the other two color coordinate points, except the center point Wₛ, within the triangle region surrounding and locating the color coordinate point W_{d}.

W_{d} is a standard white color coordinate point, and W_{d} is located at a particular triangle region, and when aberrations existing between Wₛ and W_{d}, means calibration needed for Wₛ; when calibration is performing, the rest subpixels exhibit largest influence upon the white subpixels within the triangle region; therefore, the calibration is performed by adopting two subpixels corresponding to the other two color coordinate points, except Wₛ, within the triangle region surrounding and locating the color coordinate point W_{d}, and when the calibration is performed, influences of the two subpixels is confirmed by a predetermined normalized proportion.

The predetermined normalized proportion not only can be confirmed by performing calculations of coordinate values and standard optical calculating formulas, but can also be confirmed by experimental data.

Step 105: exporting the post-compensated a second data of image pixels based on the RGBW color space.

In embodiments of the present invention, when aberrations exist between a color coordinate point Wₛ of white pixels of image pixels and a standard white color coordinate point W_{d} under sRGB, color coordinates of every subpixel of the image pixels on the RGBW panel are analyzed, and then a triangle RₛGₛBₛ with vertices color coordinate points Rₛ, Gₛ, and Bₛ of red subpixel, green subpixel and green pixel of the image points is divided into three triangle regions, RₛGₛWₛ, RₛBₛWₛ, BₛGₛWₛ, based on taking the color coordinate point Wₛ as the center point; based on ranges of the three triangle regions, RₛGₛWₛ, RₛBₛWₛ, BₛGₛWₛ, a triangle region where the color coordinate point is located is confirmed; the first data is calibrated by performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d}. Because the first data can be calibrated by performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d}; therefore, the situation of aberrations of white subpixels can be calibrated specifically and further images of GRBW panels can be normalized.

Wherein, as shown in FIG. 3, step S104 can particularly include: substep S1041 and substep S1042.

Substep S1041: if the color coordinate point W_{d} is located within the triangle region BₛGₛWₛ, a normalized proportion calculating a luminance among subpixels, the blue subpixel, green subpixel and white subpixel, is BₛY, GₛY, WₛY, and BₛY+GₛY+WₛY=1.

Substep S1042: performing calibration process to the first data by applying the normalized proportion BₛY, GₛY, WₛY to obtain a second data of image pixels based on the RGBW color space,

R_{fo}(i)=Rₒ(i)

G_{fo}(i)=Gₒ(i)+Wₒ(i)*GₛY(i)

B_{fo}(i)=B(i)+Wₒ(i)*BₛY(i)

W_{fo}(i)=Wₒ(i)*WₛY(i),

wherein, Rₒ(i), Gₒ(i), Bₒ(i), Wₒ(i) is a first data of a pixel point i, R_{fo}(i), G_{fo}(i), B_{fo}(i), W_{fo}(i) is a second data of the pixel point i, BₛY(i), GₛY(i), WₛY(i) is a normalized proportion of a luminance among a blue subpixel, green subpixel and white subpixel of the pixel point i.

If the color coordinate point W_{d} is located within the triangle region BₛRₛWₛ, that means when calibrating, performing calibration of white subpixels can adopt blue subpixels and green subpixels to do so. In particular, a normalized proportion calculating a luminance among the blue subpixel, red subpixel and white subpixels BₛY, RₛY, WₛY, wherein BₛY+RₛY+WₛY=1. Right after normalized proportion BₛY, RₛY, WₛY is confirmed, the first data can be performed in calibrating to get the second data of image pixels according to RGBW color space.

Wherein, the first data is data based on RGBW color space, and before the first data is obtained, the original data Rᵢ, Gᵢ, Bᵢ based on RGB color space is transferred into a first data Rₒ, Gₒ, Bₒ, Wₒ based on RGBW color space by traditional RGBW transferred calculation or other calculations different from RGBW transferred calculation. Next, after implementing the method of the present invention, calibrations are performed to situations of aberrations of white subpixels to normalize images of the RGBW panels.

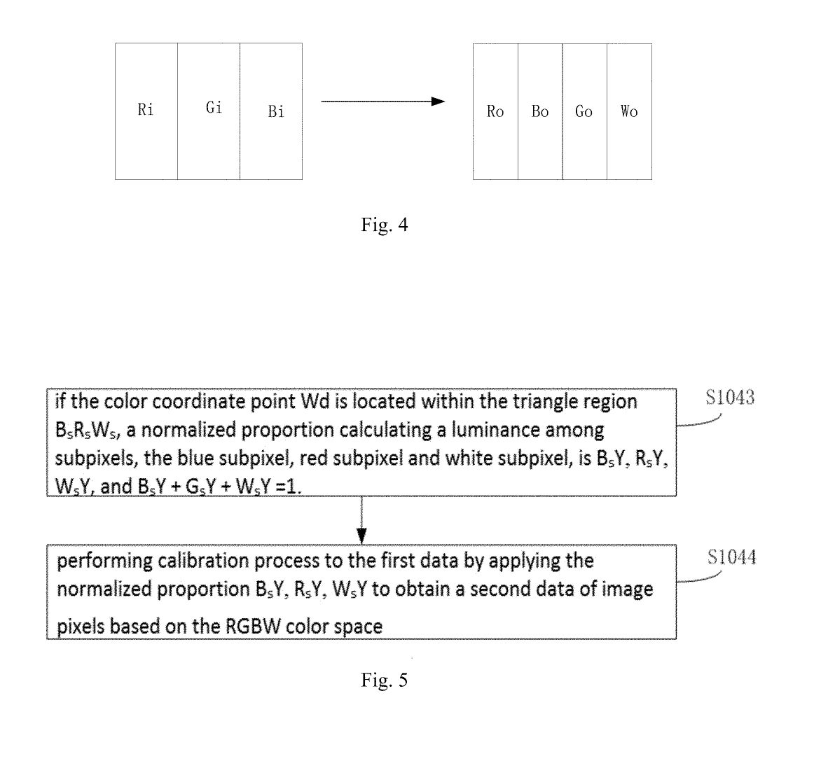

For example, as shown in FIG. 4, after transferring the original data Rᵢ, Gᵢ, Bᵢ, based on RGB color space into the first data Rₒ, Gₒ, Bₒ, Wₒ based on RGBW color space to obtain

$${R}_{o} = {R}_{i} - {W}_{o}$$

$${G}_{o} = {G}_{i} - {W}_{o}$$

$${B}_{o} = {B}_{i} - {W}_{o}$$

$${W}_{o} = min [ {R}_{i} , {G}_{i} , {B}_{i} ]$$

Next, after implementing the method of the present invention, the calibration performed to situations of aberrations of white subpixels to normalize images of the RGBW panels.

[symbol]

$${R}_{o} = {R}_{i} - {W}_{o}$$

$${G}_{o} = {G}_{i} - {W}_{o}$$

$${B}_{o} = {B}_{i} - {W}_{o}$$

$${W}_{o} = min [ {R}_{i} , {G}_{i} , {B}_{i} ] .$$

Wherein, the normalized proportion BₛY, GₛY, WₛY is obtained according to a formula 1, and the formula 1 is:

$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} Y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} , \\ BsY = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

The derivation of the aforementioned formula 1 is as following: X, Y and Z are three stimulus values, wherein, Y represents luminance; x and y are color coordinate values;

Fixed conjunctive formulas are existing between (X, Y, Z) and (x, y):

x=X/(X+Y+Z)

y=Y/(X+Y+Z)

According to the aforementioned conjunctive formulas, the next formula can be obtained:

WₛX/(WₛX+WₛY+WₛZ)=Wₛx (1)

WₛY/(WₛX+WₛY+WₛZ)=Wₛy (2)

GₛX/(GₛX+GₛY+GₛZ)=Gₛx (3)

GₛY/(GₛX+GₛY+GₛZ)=Gₛy (4)

BₛX/(BₛX+BₛY+BₛZ)=Bₛx (5)

BₛY/(BₛX+BₛY+BₛZ)=Bₛy (6)

WₛY+GₛY+BₛY=1 (7)

(WₛX+GₛX+BₛX)/(WₛX+GₛX+BₛX+WₛY+GₛY+BₛY+WₛZ+GₛZ+BₛZ)=W_{d}x (8)

(WₛY+GₛY+BₛY)/(WₛX+GₛX+BₛX+WₛY+GₛY+BₛY+WₛZ+GₛZ+BₛZ)=W_{d}y (9)

In the aforementioned 9 formulas, WₛX, WₛY and WₛZ are three respective stimulus values of a white pixel of a particular pixel and are unknowns to find a solution; GₛX, GₛY and GₛZ are three respective stimulus values of a green pixel of a particular pixel and are unknowns to find a solution; BₛX, BₛY and BₛZ are three respective stimulus values of a blue pixel of a particular pixel and are unknowns to find a solution. (Bₛx, Bₛy) is a coordinate value of the blue subpixel of the image pixel on RGBW panel, and is a known value on RGBW panel; (Gₛx, Gₛy) is a coordinate value of the green subpixel of the image pixel on RGBW panel, and is a known value on RGBW panel; (Wₛx, Wₛy) is a coordinate value of the white subpixel of the image pixel on RGBW panel, and is a known value on RGBW panel; (W_{d}x, W_{d}y) is a standard white coordinate under sRGB, and is a known value.

In the aforementioned 9 formulas, after solving 9 unknowns, luminance signal thereof can be solved then: WₛY, GₛY and BₛY is also a normalized proportion.

Wherein, as shown in FIG. 5, step S104 can particularly include: substep S1043 and sub step S1044.

Substep S1043: if the color coordinate point W_{d} is located within the triangle region BₛRₛWₛ, a normalized proportion calculating a luminance among subpixels, the blue subpixel, red subpixel and white subpixel, is BₛY, RₛY, WₛY, and BₛY+RₛY+WₛY=1.

Substep S1044: performing calibration process to the first data by applying the normalized proportion BₛY, RₛY, WₛY to obtain a second data of image pixels based on the RGBW color space,

R_{fo}(j)=Rₒ(j)+Wₒ(j)*RₛY(j)

G_{fo}(j)=Gₒ(j)

B_{fo}(j)=Bₒ(j)+Wₒ(j)*BₛY(j)

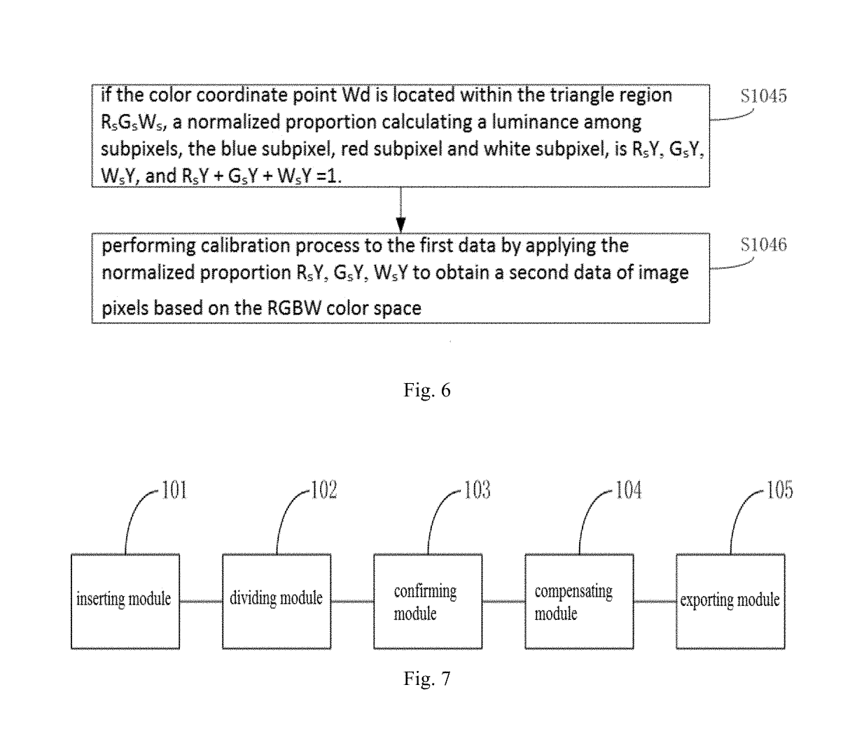

W_{fo}(j)=Wₒ(j)*WₛY(j),

wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, green subpixel and white subpixel of the pixel point j.

Wherein, the normalized proportion BₛY, RₛY, WₛY is obtained according to a formula 2, and the formula 2 is:

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, as shown in FIG. 6, step S104 can particularly include: substep S1045 and substep S1046.

Substep S1045: if the color coordinate point W_{d} is located within the triangle region RₛGₛWₛ, a normalized proportion calculating a luminance among subpixels, the red subpixel, green subpixel and white subpixel, is RₛY, GₛY, WₛY, and RₛY+GₛY+WₛY=1.

Substep S1046: performing calibration process to the first data by applying the normalized proportion RₛY, GₛY, WₛY to obtain a second data of image pixels based on the RGBW color space,

R_{fo}(k)=Rₒ(k)+Wₒ(k)*RₛY(k)

G_{fo}(k)=Gₒ(k)+Wₒ(k)*GₛY(k)

B_{fo}(k)=Bₒ(k)

W_{fo}(k)=Wₒ(k)*WₛY(k),

wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a blue subpixel, green subpixel and white subpixel of the pixel point k.

Wherein, the normalized proportion RₛY, GₛY, WₛY is obtained according to a formula 3, and the formula 3 is:

$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Refer to FIG. 7, FIG. 7 is a schematic diagram showing a structure of an apparatus of an embodiment for compensation based on color aberrations of white subpixel; the apparatus can implementing the steps in the aforementioned method, and detail descriptions of relative contents can refer to corresponding description in the aforementioned method and will not be repeated here.

Aberrations exist between a color coordinate point Wₛ of white subpixel of image pixels on a RGBW panel and a standard white color coordinate point W_{d} under sRGB before compensating, and the apparatus comprises: an inserting module 101, a dividing module 102, a confirming module 103, a compensating module 104 and an exporting module 105.

The inserting module 101 is used in inserting the image pixels based on a first data of RGBW color space.

The dividing module 102 is used in analyzing color coordinates of every subpixel of the image pixels on the RGBW panel, and then dividing a triangle RₛGₛBₛ with vertices color coordinate points Rₛ, Gₛ and Bₛ of red subpixel, green subpixel and green pixel of the image points into three triangle regions, RₛGₛWₛ, RₛBₛWₛ, BₛGₛWₛ, based on taking the color coordinate point Wₛ as the center point.

The confirming module 103 is used in confirming a triangle region where the color coordinate point is located based on ranges of the three triangle regions, RₛGₛWₛ, RₛBₛWₛ, BₛGₛWₛ.

The compensating module 104 is used in performing compensating the white subpixel corresponding by the center point Wₛ via a predetermined normalized proportion to calibrate the first data through two subpixels corresponding to the other two color coordinate points, except the center point Wₛ, within the triangle region surrounding and locating the color coordinate point W_{d}.

The exporting module 105 is used in exporting the post-compensated a second data of image pixels based on the RGBW color space.

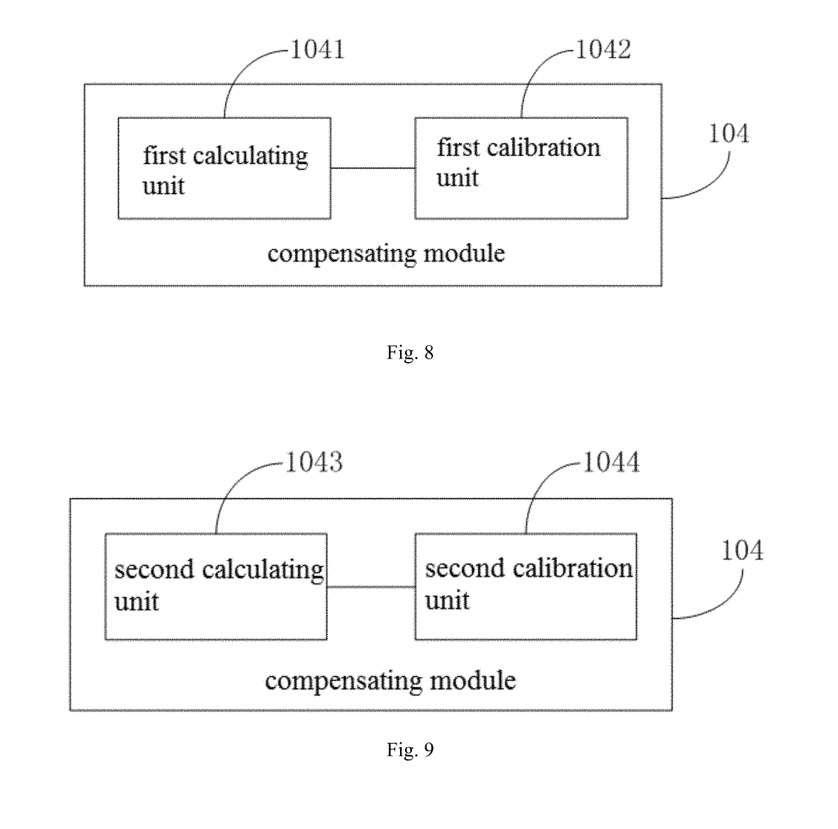

In embodiments of the present invention, when aberrations exist between a color coordinate point Wₛ of white pixels of image pixels and a standard white color coordinate point W_{d} under sRGB, color coordinates of every subpixel of the image pixels on the RGBW panel are analyzed, and then a triangle RₛGₛBₛ with vertices color coordinate points Rₛ, Gₛ and Bₛ of red subpixel, green subpixel and green pixel of the image points is divided into three triangle regions, RₛGₛWₛ, RₛBₛWₛ, BₛGₛWₛ, based on taking the color coordinate point Wₛ as the center point; based on ranges of the three triangle regions, RₛGₛWₛ, RₛBₛWₛ, BₛGₛWₛ, a triangle region where the color coordinate point is located is confirmed; the first data is calibrated by performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d}. Because the first data can be calibrated by performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d}; therefore, the situation of aberrations of white subpixels can be calibrated specifically and further images of RGBW panels can be normalized.

Wherein, refer to FIG. 8, the compensating module 104 comprises: a first calculating unit 1041 and a first calibration unit 1042.

The first calculating unit 1041 is used in while the color coordinate point W_{d} is located within the triangle region BₛGₛWₛ, a normalized proportion calculating a luminance among subpixels, the blue subpixel, green subpixel and white subpixel, is BₛY, GₛY, WₛY, and BₛY+GₛY+WₛY=1.

The first calibration unit 1042 is used in performing the calibration process to the first data by applying the normalized proportion BₛY, GₛY, WₛY to obtain a second data of image pixels based on the RGBW color space,

R_{fo}(i)=Rₒ(i)

G_{fo}(i)=Gₒ(i)+Wₒ(i)*GₛY(i)

B_{fo}(i)=Bₒ(i)+Wₒ(i)*BₛY(i)

W_{fo}(i)=Wₒ(i)*WₛY(i),

wherein, Rₒ(i), Gₒ(i), Bₒ(i), Wₒ(i) is a first data of a pixel point i, R_{fo}(i), G_{fo}(i), B_{fo}(i), W_{fo} (i) is a second data of the pixel point i, BₛY(i), GₛY(i), WₛY(i) is a normalized proportion of a luminance among a blue subpixel, green subpixel and white subpixel of the pixel point i.

Wherein, the normalized proportion BₛY, GₛY, WₛY is obtained according to a formula 1, and the formula 1 is:

$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, refer to FIG. 9, the compensating module 104 comprises: a second calculating unit 1043 and a second calibration unit 1044.

The second calculating unit 1043 is used in while the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1.

The second calibration unit 1044 is used in performing calibration process to the first data by applying the normalized proportion BₛY, RₛY, WₛY to obtain a second data of image pixels based on the RGBW color space,

R_{fo}(j)=Rₒ(j)+Wₒ(j)*RₛY(j)

G_{fo}(j)=Gₒ(j)

B_{fo}(j)=Bₒ(j)+Wₒ(i)*BₛY(j)

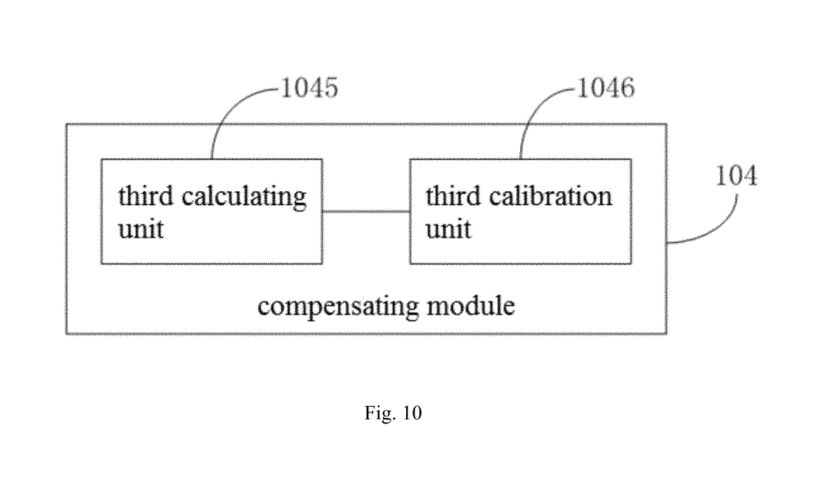

W_{fo}(j)=Wₒ(j)*WₛY(j),

wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, red subpixel and white subpixel of the pixel point j.

Wherein, the normalized proportion BₛY, RₛY, WₛY is obtained according to a formula 2, and the formula 2 is:

$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$

$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$

$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Wherein, refer to FIG. 10, the compensating module 104 comprises: a third calculating unit 1045 and a third calibration unit 1046.

The third calculating unit 1045 is used in while the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1.

The third calibration unit 1046 is used in performing calibration process to the first data by applying the normalized proportion RₛY, GₛY, WₛY to obtain a second data of image pixels based on the RGBW color space,

R_{fo}(k)=Rₒ(k)+Wₒ(k)*RₛY(k)

G_{fo}(k)=Gₒ(k)+Wₒ(k)*GₛY(k)

B_{fo}(k)=Bₒ(k)

W_{fo}(k)=Wₒ(k)*WₛY(k),

wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

Wherein, the normalized proportion RₛY, GₛY, WₛY is obtained according to a formula 3, and the formula 3 is:

$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$

$${R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$

wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

Even though information and the advantages of the present embodiments have been set forth in the foregoing description, together with details of the mechanisms and functions of the present embodiments, the disclosure is illustrative only; and that changes may be made in detail, especially in matters of shape, size and arrangement of parts within the principles of the present embodiments to the full extend indicated by the broad general meaning of the terms in which the appended claims are expressed.

1. A method of RGBW compensation based on color aberrations of white subpixel, wherein, aberrations exist between a color coordinate point Wₛ of white subpixel of image pixels on a RGBW panel and a standard white color coordinate point W_{d} under sRGB before compensating, and the method comprises:
inserting the image pixels based on a first data of RGBW color space;
analyzing color coordinates of every subpixel of the image pixels on the RGBW panel, and then dividing a triangle RₛGₛBₛ with vertices color coordinate points Rₛ, Gₛ, and Bₛ, of red subpixel, green subpixel and green pixel of the image points into three triangle regions, RₛGₛWₛ, RₛBₛWₛ, BₛGₛWₛ, based on taking the color coordinate point Wₛ as the center point;
confirming a triangle region where the color coordinate point is located based on ranges of the three triangle regions, RₛGₛWₛ, RₛBₛWₛ, BₛGₛWₛ;
performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d};
exporting the post-compensated a second data of image pixels based on the RGBW color space;
wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d} comprises:
if the color coordinate point W_{d} is located within the triangle region BₛGₛWₛ, a normalized proportion calculating a luminance among subpixels, the blue subpixel, green subpixel and white subpixel, is BₛY, GₛY, WₛY, and BₛY+GₛY+WₛY=1;
performing calibration process to the first data by applying the normalized proportion BₛY, GₛY, WₛY to obtain a second data of image pixels based on the RGBW color space,
R_{fo}(i)=Rₒ(i)
G_{fo}(i)=Gₒ(i)+Wₒ(i)*GₛY(i)
B_{fo}(i)=Bₒ(i)+Wₒ(i)*BₛY(i)
W_{fo}(i)=Wₒ(i)*WₛY(i),
wherein, Rₒ(i), Gₒ(i), Bₒ(i), Wₒ(i) is a first data of a pixel point i, R_{fo}(i), G_{fo}(i), B_{fo}(i), W_{fo}(i) is a second data of the pixel point i, BₛY(i), GₛY(i), WₛY(i) is a normalized proportion of a luminance among a blue subpixel, green subpixel and white subpixel of the pixel point i;
if the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1;
performing calibration process to the first data by applying the normalized proportion BₛY, RₛY, WₛY to obtain a second data of image pixels based on the RGBW color space,
R_{fo}(i)=Rₒ(i)+Wₒ(j)*RₛY(j)
G_{fo}(j)=Gₒ(j)
B_{fo}(j)=Bₒ(j)+Wₒ(j)*BₛY(j)
W_{fo}(j)=Wₒ(j)*WₛY(j),
wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, red subpixel and white subpixel of the pixel point j;
if the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1;
performing calibration process to the first data by applying the normalized proportion RₛY, GₛY, WₛY to obtain a second data of image pixels based on the RGBW color space,
R_{fo}(k)=Rₒ(k)+Wₒ(k)*RₛY(k)
G_{fo}(k)=Gₒ(k)+Wₒ(k)*GₛY(k)
B_{fo}(k)=Bₒ(k)
W_{fo}(k)=Wₒ(k)*WₛY(k),
wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

2. The method according to claim 1, wherein, the normalized proportion BₛY, GₛY, WₛY is obtained according to a formula 1, and the formula 1 is:
$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

3. The method according to claim 1, wherein, the normalized proportion BₛY, RₛY, WₛY is obtained according to a formula 2, and the formula 2 is:
$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$
$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$
$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

4. The method according to claim 1, wherein, the normalized proportion RₛY, GₛY, WₛY is obtained according to a formula 3, and the formula 3 is:
$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

5. A method of RGBW compensation based on color aberrations of white subpixel, wherein, aberrations exist between a color coordinate point Wₛ of white subpixel of image pixels on a RGBW panel and a standard white color coordinate point W_{d} under sRGB before compensating, and the method comprises:
inserting the image pixels based on a first data of RGBW color space;
analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Was the center point;
confirming a triangle region where the color coordinate point is located based on ranges of the three triangle regions, RₛGₛWₛ, RₛBₛWₛ, BₛGₛWₛ;
performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d};
exporting the post-compensated a second data of image pixels based on the RGBW color space.

6. The method according to claim 5, wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d} comprises:
if the color coordinate point W_{d} is located within the triangle region BₛGₛWₛ, a normalized proportion calculating a luminance among subpixel, the blue subpixel, green subpixel and white subpixel, is BₛY, GₛY, WₛY, and BₛY+GₛY+WₛY=1;
performing calibration process to the first data by applying the normalized proportion BₛY, GₛY, WₛY to obtain a second data of image pixels based on the RGBW color space,
R_{fo}(i)=Rₒ(i)
G_{fo}(i)=Gₒ(i)+Wₒ(i)*GₛY(i)
B_{fo}(i)=Bₒ(i)+Wₒ(i)*BₛY(i)
W_{fo}(i)=Wₒ(i)*WₛY(i),
wherein, Rₒ(i), Gₒ(i), Bₒ(i), Wₒ(i) is a first data of a pixel point i, R_{fo}(i), G_{fo}(i), B_{fo}(i), W_{fo} (i) is a second data of the pixel point i, BₛY(i), GₛY(i), WₛY(i) is a normalized proportion of a luminance among a blue subpixel, green subpixel and white subpixel of the pixel point i.

7. The method according to claim 6, wherein, the normalized proportion BₛY, GₛY, WₛY is obtained according to a formula 1, and the formula 1 is:
$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

8. The method according to claim 5, wherein, steps for performing compensating the white subpixel corresponding by the center point Wₛ via a predetermined normalized proportion to calibrated the first data through the two subpixels corresponding to the other two color coordinate points, except the center point Wₛ, within the triangle region surrounding and locating the color coordinate point W_{d} comprises:
if the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1;
performing calibration process to the first data by applying the normalized proportion BₛY, RₛY, WₛY to obtain a second data of image pixels based on the RGBW color space,
R_{fo}(j)=Rₒ(j)+Wₒ(j)*RₛY(j)
G_{fo}(j)=Gₒ(j)
B_{fo}(j)=Bₒ(j)+Wₒ(j)*BₛY(j)
W_{fo}(j)=Wₒ(j)*WₛY(j),
wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, red subpixel and white subpixel of the pixel point j.

9. The method according to claim 8, wherein, the normalized proportion BₛY, RₛY, WₛY is obtained according to a formula 2, and the formula 2 is:
$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$
$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$
$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

10. The method according to claim 5, wherein, steps of performing compensating the white subpixel corresponding by the center point Wₛ via a predetermined normalized proportion through two subpixels corresponding to the other two color coordinate points, except the center point Wₛ, within the triangle region surrounding and locating the color coordinate point W_{d} comprises:
if the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1;
performing calibration process to the first data by applying the normalized proportion RₛY, GₛY, WₛY to obtain a second data of image pixels based on the RGBW color space,
R_{fo}(k)=Rₒ(k)+Wₒ(k)*RₛY(k)
G_{fo}(k)=Gₒ(k)+Wₒ(k)*GₛY(k)
B_{fo}(k)=Bₒ(k)
W_{fo}(k)=Wₒ(k)*WₛY(k),
wherein, Rₒ(k), Gₒ(k), Bₒ(k), Wₒ(k) is a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

11. The method according to claim 10, wherein, wherein, the normalized proportion RₛY, GₛY, WₛY is obtained according to a formula 3, and the formula 3 is:
$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

12. An apparatus of RGBW compensation based on color aberrations of white subpixel, wherein, aberrations exist between a color coordinate point Wₛ of white subpixel of image pixels on a RGBW panel and a color coordinate point W_{d} of standard white subpixel within sRGB before compensating, and the apparatus comprises:
an inserting module, used in inserting the image pixels based on a first data of RGBW color space;
a dividing module, used in analyzing color coordinates of every subpixel of the image pixels on the RGBW panel, and then dividing a triangle RₛGₛBₛ with vertices color coordinate points Rₛ, Gₛ, and Bₛ of red subpixel, green subpixel and green pixel of the image points into three triangle regions, RₛGₛWₛ, RₛBₛWₛ, BₛGₛWₛ, based on taking the color coordinate point Wₛ as the center point;
a confirming module, used in confirming a triangle region where the color coordinate point is located based on ranges of the three triangle regions, RₛGₛWₛ, RₛBₛWₛ, BₛGₛWₛ;
a compensating module, used in performing compensating the white subpixel corresponding by the center point Wₛ via a predetermined normalized proportion to calibrated the first data through two subpixels corresponding to the other two color coordinate points, except the center point Wₛ, within the triangle region surrounding and locating the color coordinate point W_{d};
an exporting module, used in exporting the post-compensated a second data of image pixels based on the RGBW color space.

13. The apparatus of claim 12, wherein, the compensating module comprises:
a first calculating unit, used in while the color coordinate point W_{d} is located within the triangle region BₛGₛWₛ, a normalized proportion calculating a luminance among subpixels, the blue subpixel, green subpixel and white subpixel, is BₛY, GₛY, WₛY, and BₛY+GₛY+WₛY=1;
a first calibration unit, used in performing the calibration process to the first data by applying the normalized proportion BₛY, GₛY, WₛY to obtain a second data of image pixels based on the RGBW color space,
R_{fo}(i)=Rₒ(i)
G_{fo}(i)=Gₒ(i)+Wₒ(i)*GₛY(i)
B_{fo}(i)=Bₒ(i)+Wₒ(i)*BₛY(i)
W_{fo}(i)=Wₒ(i)*WₛY(i),
wherein, Rₒ(i), Gₒ(i), Bₒ(i), Wₒ(i) i s a first data of a pixel point i, R_{fo}(i), G_{fo}(i), B_{fo}(i), W_{fo}(i) is a second data of the pixel point i, BₛY(i), GₛY(i), WₛY(i) is a normalized proportion of a luminance among a blue subpixel, green subpixel and white subpixel of the pixel point i.

14. The apparatus of the claim 13, wherein, the normalized proportion BₛY, GₛY, WₛY is obtained according to a formula 1, and the formula 1 is:
$${W}_{s} Y = \frac{\begin{matrix}{B}_{s} x * {G}_{s} y * {W}_{s} y - {B}_{s} y * {G}_{s} x * {W}_{s} y - {B}_{s} x * {W}_{s} y * {W}_{d} y + \\ {B}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{B}_{s} x * {G}_{s} y * {W}_{s} y - {B}_{s} y * {G}_{s} y * {W}_{s} x - {B}_{s} x * {G}_{s} y * {W}_{d} y + \\ {B}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${B}_{s} Y = \frac{\begin{matrix}{B}_{s} y * {G}_{s} x * {W}_{s} y - {B}_{s} y * {G}_{s} y * {W}_{s} x - {B}_{s} y * {G}_{s} x * {W}_{d} y + \\ {B}_{s} y * {G}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {G}_{s} y * {W}_{d} y - {B}_{s} y * {G}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

15. The apparatus according to claim 12, wherein, the compensating module comprises:
a second calculating unit, used in while the color coordinate point W_{d} is located within the triangle region BₛRₛWₛ, a normalized proportion calculating a luminance among the blue subpixel, red subpixel and white subpixel, is BₛY, RₛY, WₛY, and BₛY+RₛY+WₛY=1;
a second calibration unit, used in performing calibration process to the first data by applying the normalized proportion BₛY, RₛY, WₛY to obtain a second data of image pixels based on the RGBW color space,
R_{fo}(j)=Rₒ(j)+Wₒ(j)*RₛY(j)
G_{fo}(j)=Gₒ(j)
B_{fo}(j)=Bₒ(j)+Wₒ(j)*RₛY(j)
W_{fo}(j)=Wₒ(j)*WₛY(j),
wherein, Rₒ(j), Gₒ(j), Bₒ(j), Wₒ(j) is a first data of a pixel point j, R_{fo}(j), G_{fo}(j), B_{fo}(j), W_{fo}(j) is a second data of the pixel point j, BₛY(j), RₛY(j), WₛY(j) is a normalized proportion of a luminance among a blue subpixel, red subpixel and white subpixel of the pixel point j.

16. The apparatus according to claim 15, wherein, the normalized proportion BₛY, RₛY, WₛY is obtained according to a formula 2, and the formula 2 is:
$${W}_{s} Y = \frac{\begin{matrix}{B}_{s} x * {R}_{s} y * {W}_{s} y - {B}_{s} y * {R}_{s} x * {W}_{s} y - {B}_{s} x * {W}_{s} y * {W}_{d} y + \\ {B}_{s} y * {W}_{s} y * {W}_{d} x + {R}_{s} x * {W}_{s} y * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {G}_{s} x * {W}_{s} y * {W}_{d} y - {R}_{s} y * {W}_{s} x * {W}_{d} y\end{matrix}}$$
$${R}_{s} Y = \frac{\begin{matrix}{B}_{s} x * {R}_{s} y * {W}_{s} y - {B}_{s} y * {R}_{s} y * {W}_{s} x - {B}_{s} x * {R}_{s} y * {W}_{d} y + \\ {B}_{s} y * {R}_{s} y * {W}_{d} x + {R}_{s} y * {W}_{s} x * {W}_{d} y - {R}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}}$$
$${B}_{s} Y = \frac{\begin{matrix}{B}_{s} y * {R}_{s} x * {W}_{s} y - {B}_{s} y * {R}_{s} y * {W}_{s} x - {B}_{s} y * {R}_{s} x * {W}_{d} y + \\ {B}_{s} y * {R}_{s} y * {W}_{d} x + {B}_{s} y * {W}_{s} x * {W}_{d} y - {B}_{s} y * {W}_{s} y * {W}_{d} x\end{matrix}}{\begin{matrix}{B}_{s} x * {R}_{s} y * {W}_{d} y - {B}_{s} y * {R}_{s} x * {W}_{d} y - {B}_{s} x * {W}_{s} y * {W}_{d} y + \\ {B}_{s} y * {W}_{s} x * {W}_{d} y + {R}_{s} x * {W}_{s} y * {W}_{d} y - {R}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.

17. The apparatus according to claim 12, wherein, the compensating module comprises:
a third calculating unit, used in while the color coordinate point W_{d} is located within the triangle region RₛGₛWₛ, a normalized proportion calculating a luminance among the red subpixel, green subpixel and white subpixel, is RₛY, GₛY, WₛY, and RₛY+GₛY+WₛY=1;
a third calibration unit, used in performing calibration process to the first data by applying the normalized proportion RₛY, GₛY, WₛY to obtain a second data of image pixels based on the RGBW color space,
R_{fo}(k)=Rₒ(k)+Wₒ(k)*RₛY(k)
G_{fo}(k)=Gₒ(k)+Wₒ(k)*GₛY(k)
B_{fo}(k)=Bₒ(k)
W_{fo}(k)=Wₒ(k)*WₛY(k),
wherein, Rₒ(k), Gₒ(k), Bₒ(k), Wₒ(k) i s a first data of a pixel point k, R_{fo}(k), G_{fo}(k), B_{fo}(k), W_{fo}(k) is a second data of the pixel point k, RₛY(k), GₛY(k), WₛY(k) is a normalized proportion of a luminance among a red subpixel, green subpixel and white subpixel of the pixel point k.

18. The apparatus according to claim 17, wherein, the normalized proportion RₛY, GₛY, WₛY is obtained according to a formula 3, and the formula 3 is:
$${W}_{s} Y = \frac{\begin{matrix}{R}_{s} x * {G}_{s} y * {W}_{s} y - {R}_{s} y * {G}_{s} x * {W}_{s} y - {R}_{s} x * {W}_{s} y * {W}_{d} y + \\ {R}_{s} y * {W}_{s} y * {W}_{d} x + {G}_{s} x * {W}_{s} y * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${G}_{s} Y = \frac{\begin{matrix}{R}_{s} x * {G}_{s} y * {W}_{s} y - {R}_{s} y * {G}_{s} y * {W}_{s} x - {R}_{s} x * {G}_{s} y * {W}_{d} y + \\ {R}_{s} y * {G}_{s} y * {W}_{d} x + {G}_{s} y * {W}_{s} x * {W}_{d} y - {G}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}}$$
$${R}_{s} Y = \frac{\begin{matrix}{R}_{s} y * {G}_{s} x * {W}_{s} y - {R}_{s} y * {G}_{s} y * {W}_{s} x - {R}_{s} y * {G}_{s} x * {W}_{d} y + \\ {R}_{s} y * {G}_{s} y * {W}_{d} x + {R}_{s} y * {W}_{s} x * {W}_{d} y - {R}_{s} y * {W}_{s} y * {W}_{d} x\end{matrix}}{\begin{matrix}{R}_{s} x * {G}_{s} y * {W}_{d} y - {R}_{s} y * {G}_{s} x * {W}_{d} y - {R}_{s} x * {W}_{s} y * {W}_{d} y + \\ {R}_{s} y * {W}_{s} x * {W}_{d} y + {G}_{s} x * {W}_{s} y * {W}_{d} y - {G}_{s} y * {W}_{s} x * {W}_{d} y\end{matrix}} ,$$
wherein, (Bₛx,Bₛy) is a coordinate of a coordinate point of blue subpixel of a pixel point, (Gₛx,Gₛy) is a coordinate of a coordinate point of green subpixel of the pixel point, (Wₛx,Wₛy) is a coordinate of a coordinate point of white subpixel of the pixel point, and (W_{d}x,W_{d}y) is a coordinate of a standard white color coordinate point under sRGB.
